(19) United States
(12) Patent Application Publication
(10) Pub. No.: US 2017/0156487 A1
(43) Pub. Date: Jun. 8, 2017

(54) BI-FOLD TABLE

(71) Applicant: Larry Tang, East Brunswick, NJ (US)

(72) Inventor: Larry Tang, East Brunswick, NJ (US)

(21) Appl. No.: 15/351,567

(22) Filed: Nov. 15, 2016

Related U.S. Application Data
(60) Provisional application No. 62/263,977, filed on Dec. 7, 2015.

(51) Int. Cl. A47B 3/087; B29C 45/00; B29C 45/14; A47B 13/08

(52) U.S. Cl. CPC A47B 3/087; A47B 13/08; B29C 45/0001; B29C 45/14467; A47B 2003/0835

(57) ABSTRACT

A folding table including first and second solid core sections joined together at facing edges thereof, with the sections being formed through an injection molding process of a thermosetting resin.

### CROSS-REFERENCE TO RELATED APPLICATIONS

A Provisional Patent Application covering the invention described herein was filed on Dec. 7, 2015, and assigned Ser. No. 62/263,977.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

Field of the Invention

This invention relates to bi-fold tables, in general, and to improvements in their manufacture, in particular.

Description of the Related Art

As will be appreciated, bi-fold tables often find use as indoor-outdoor picnic party tables, especially for tailgating at outdoor sporting events. Also referred to as center folding tables, those typically available are composed of a medium density fiberboard with aluminum trim riveted at the edges rolling under and over the top surface of the board (with a further aluminum strip spanning across the top of each half section of the board where they meet, likewise riveted in place). One limitation of this table is that the fiberboard is not really rain or moisture proof, so that the table does not really become an all-weather product. Another limitation is that the fiberboard composition does not take a very good printed surface or other type graphics. When unfurled and opened, furthermore, a person sitting at the long side of the table finds that the aluminum strips on its top surface makes resting one's arms thereupon somewhat uncomfortable. Attempting to write on the table then becomes less than optimum, because of the raised bump of the aluminum strip. This further limits the use of the bi-fold table as a breakfast-in-bed table, and as a work table using a tablet or laptop.

Utilizing a blow molding process to fabricate a table of this sort, however, necessitates a molding of two separate half tables of double wall thickness each, between which an air pocket is formed—with this followed by a subsequent drilling of holes, the adding of a steel plate at their juncture, and a joining of the two halves together with rivets or nuts and bolts. And, because of the very nature of the air pocket fabrication, the printing or graphic impressioning on the top wall surface gives rise to restriction in the degree of force that can be applied in providing the impressioning on the top.

Moreover, such prior art constructions, by their very nature would cause added difficulties in trying to provide a storage box for toys or stationary on the underside of the tabletop, or a compartment for various uses (such as a built-in bluetooth speaker or WIFI router, etc.) as to do so, would require a drilling of at least one hole on the tabletop to be used as an affixing point in grasping the box underneath—thereby requiring a further “bump” on the tabletop surface as a stud would be needed with a cap to hold it in place. In particular for the case of a blow molded bi-fold top, a hole would need to be drilled to the lower wall and then once the box is joined, the box in and of itself would be in the way of closing—or, at the very best, sticking out. The usefulness of such storage box attached to the underside of the table, on the other hand, is obviously a desirable point in the making of a “play table” or a “learning table” where the educational items needed could be temporarily housed.

### OBJECTS OF THE INVENTION

It is an object of the present invention, therefore, to provide a new and improved bi-fold table which overcomes the disadvantages of such prior art constructions.

It is another object of the invention to provide such a table which allows for an underneath attachment of storage compartments and/or releasable table legs.

It is an object of the invention, also, to provide a bi-fold table by a single molding process by which the manners of attaching the storage compartments and releasable table legs can be addressed at the same time.

It is yet a further object of the invention to provide such a bi-fold table at a lower manufacturing cost than with alternative fabrications.

### SUMMARY OF THE INVENTION

The bi-fold table of the invention is manufactured of a hard thermosetting resin, preferably melamine formaldehyde (melamine). By employing heat curing in this manner, the prepolymer in the soft solid or viscous state is irreversibly changed into an infusible, insoluble polymer network, obviating any need for the addition of aluminum trim at the table's edges. In the same manner, integral connecting mechanisms of melamine are formed which are strong and without introducing problems of shrinkage—thereby eliminating the need for rivets or nuts and bolts to secure other trim of like appendages in place. In this respect, this does away with any aluminum trim or other bumps being provided at the edges of the table as the folding over of any aluminum trim is avoided. The need for the aluminum strips at the middle seam of the table halves is avoided as well—and because of the material employed, the tabletop becomes waterproof, harder, and able to be printed upon more easily.

As will further be seen, because of the injection molding production method of the invention, the underneath of the tabletop can be arranged to be “hollowed out”, with the side rim continued to be made of the same material in the same molding process so that the storage compartment and releasable legs can be emplaced without any occasion to stick out and be seen. As will be appreciated, this enables the bi-fold table to be used as a breakfast-in-bed table or as a lap table with the smooth top surface that can easily be printed upon. And as will become clear hereinafter, in a preferred embodiment of the invention, the connecting mechanism employed to join the halves together in opening or closing is able to be formed as part of the same injection molding as provides the tabletop as a solid core.

### BRIEF DESCRIPTION OF THE DRAWINGS

These and other features of the invention will be more clearly understood from a consideration of the following, taken in connection with the accompanying Drawings, in which:

FIGS. 1A-1C illustrate the typical medium density fiberboard type of bi-fold table conventionally available in the prior art; and

FIGS. 2A-2F, 3A-3F, 4A-4C, 5A-5D, 6A-6B, 7A-7B, 8A-8D, 9 and 10 illustrate views helpful in an understanding of the bi-fold table of the invention.

Specifically:

FIGS. 2A-2F show different positionings of the two halves of the bi-fold table in one arrangements for the injection molding production method of the invention;

FIGS. 3A-3F show positioning of the two halves of the table as would be molded for a further function box/storage compartment utilization;

FIGS. 4A-4C illustrate views of the bi-fold table of FIGS. 3A-3F as it would appear open and closed;

FIGS. 5A-5D are views helpful in an understanding of a construction of the function box/storage compartment utilization;

FIGS. 6A-6B are views helpful in understanding one form of rib arrangement at an underside of the table halves;

FIGS. 7A-7B are illustrations helpful in understanding a securement together of the two table halves;

FIGS. 8A-8D show front and side views of the hinge strut and leg assemblies of the bi-fold table;

FIG. 9 illustrates how the function box/storage compartment of the table is held in place; and

FIG. 10 shows a steel stamping usable to further strengthen the bi-fold table of the invention.

### DETAILED DESCRIPTION OF THE INVENTION

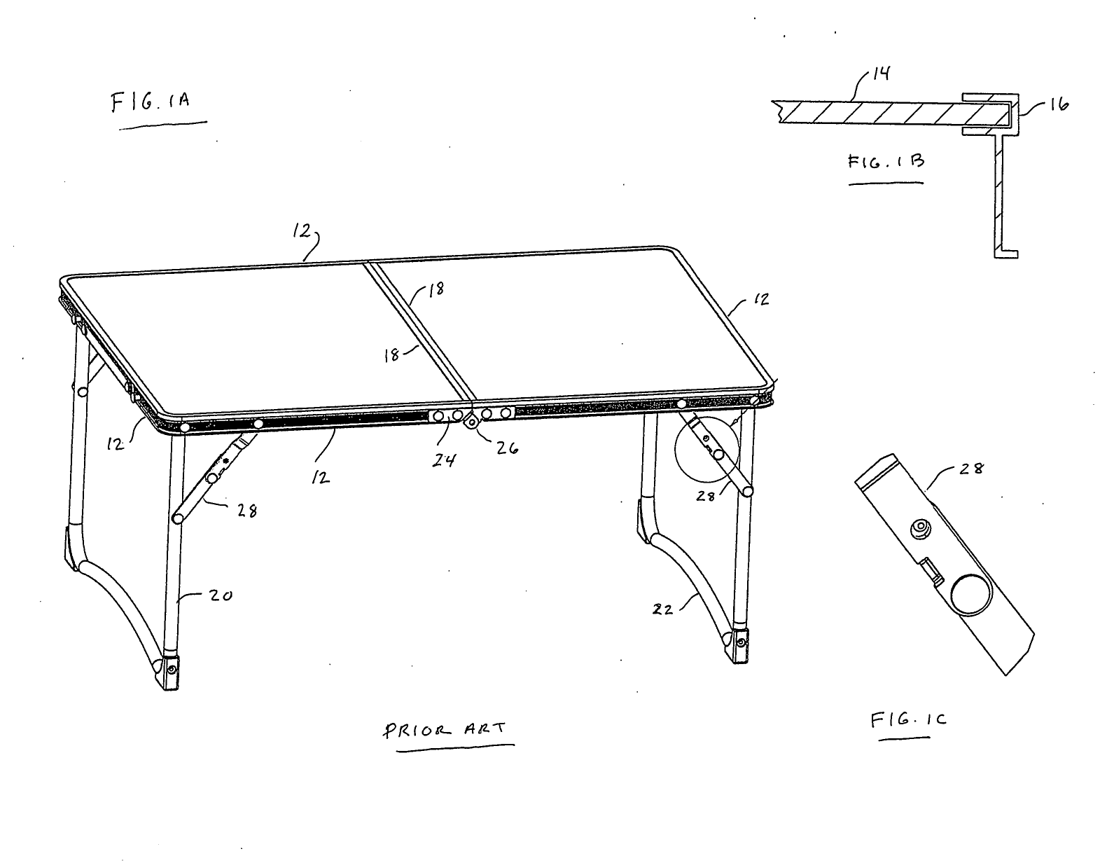

In FIGS. 1A-1C, the conventional medium density fiberboard center-folding table is shown at 10, having aluminum trim along the edges at 12, turning over and under the board 14 with the aluminum trim at 16, and the spanning aluminum strips 18. The legs of the table 10 are shown at 20, 22, respectively—and an aluminum plate 24 is riveted, further, at each of the long sides of the table. A middle rivet 26 serves to connect the two sides of the table together, and a supporting strut 28 is hinged to allow the legs 22 to collapse on each side (FIG. 1C).

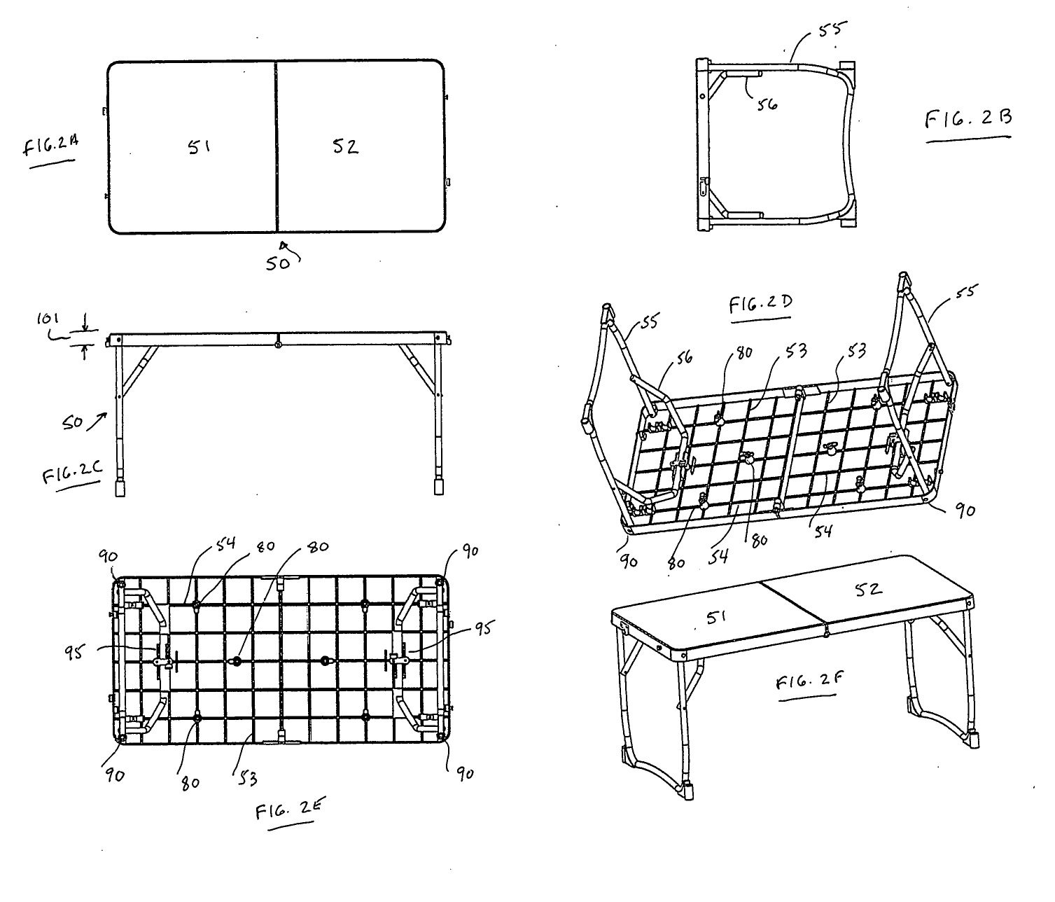

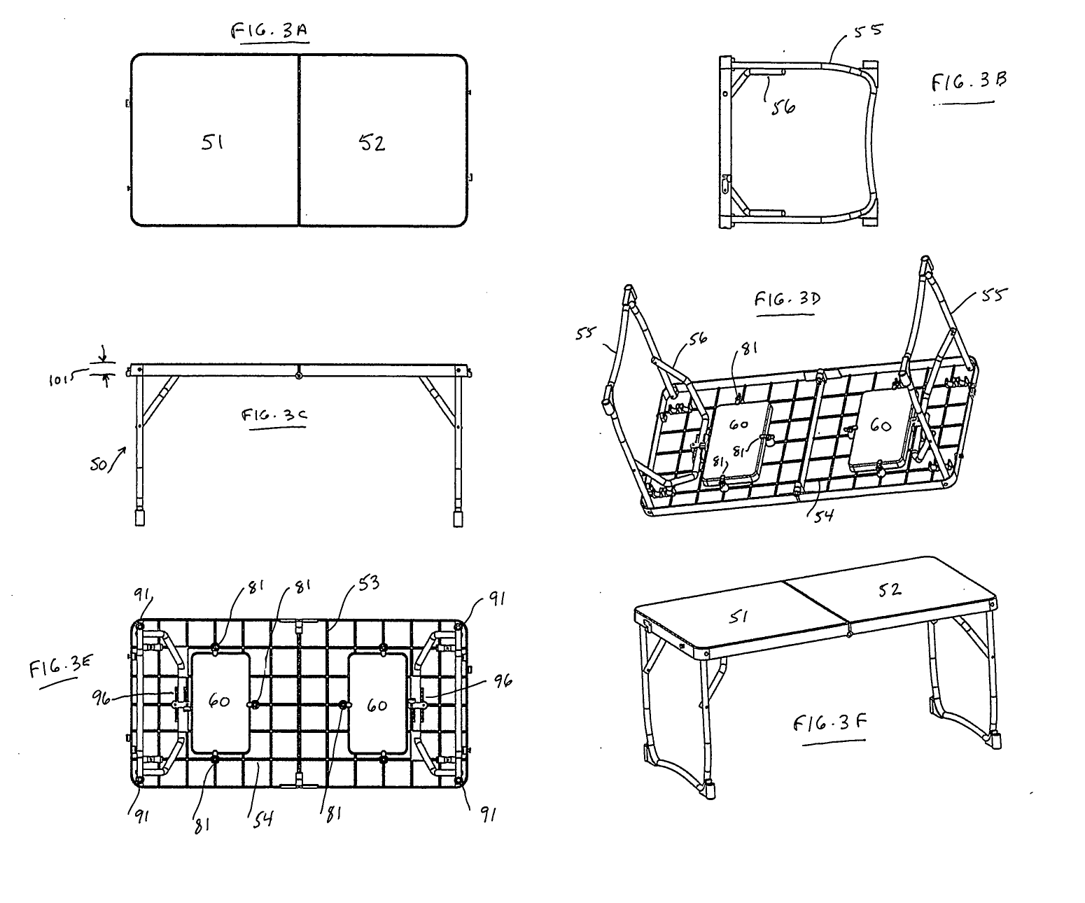

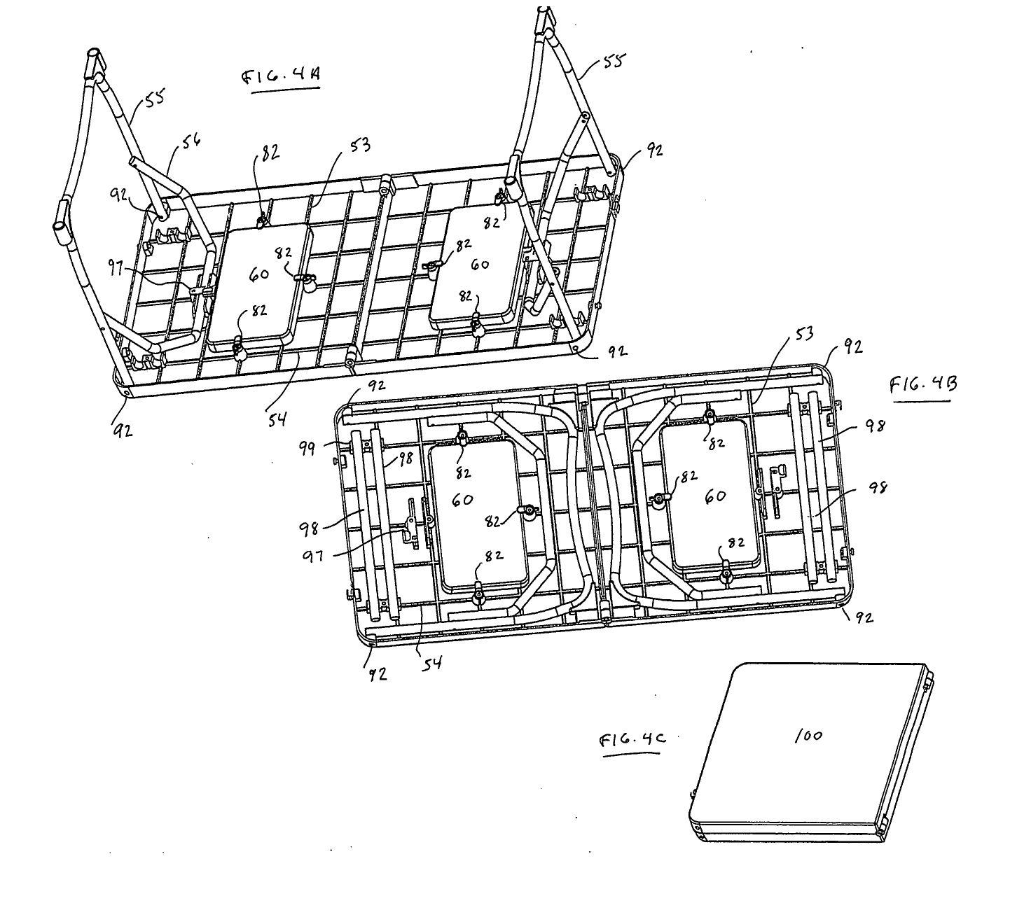

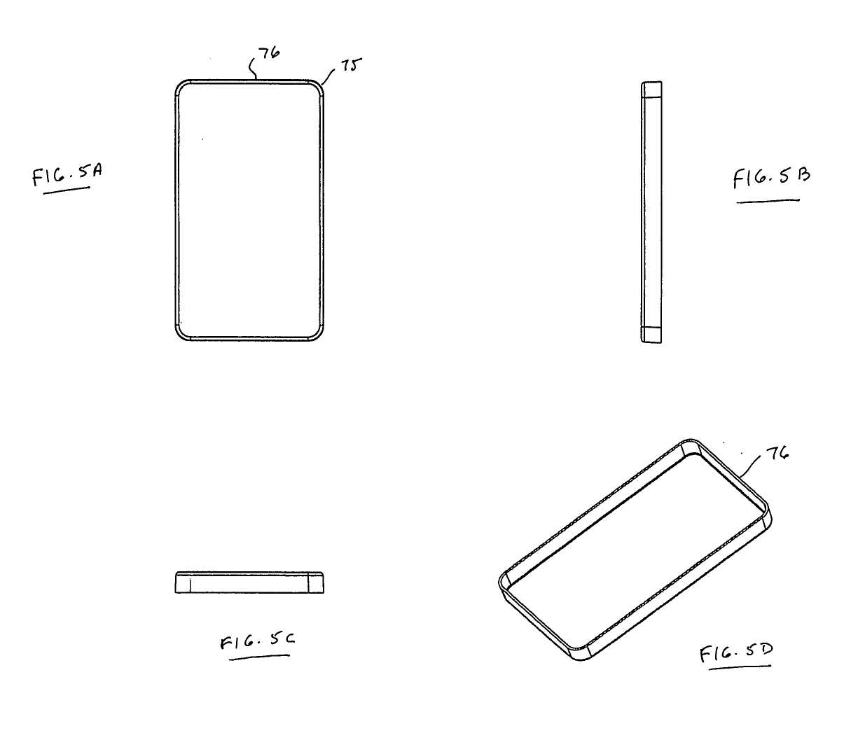

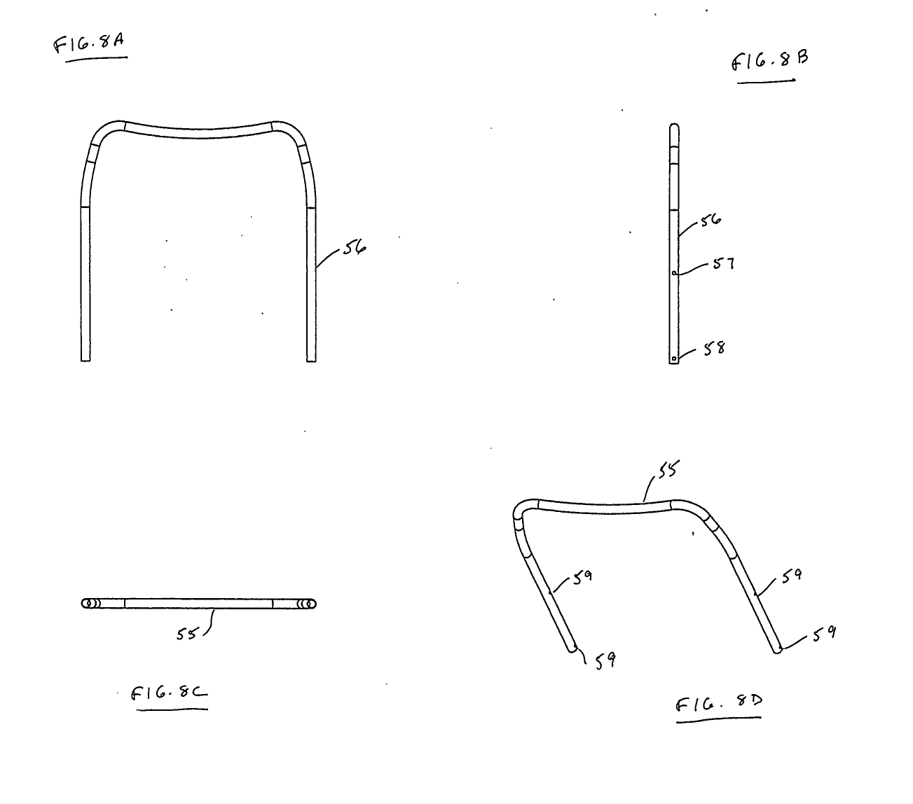

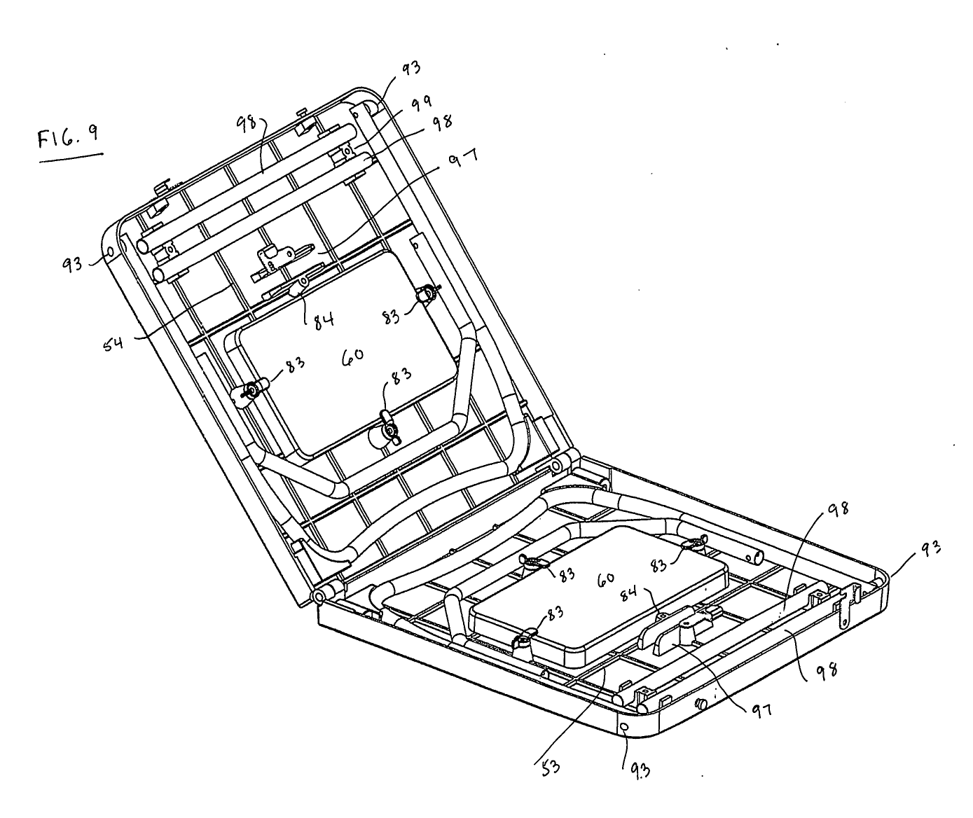

With respect to the center-folding bi-fold table of the present invention, the tabletop 50 of the invention is composed of two halves 51, 52 formed by injection molding of a thermosetting resin cured by heat, preferably melamine formaldehyde (melamine) in which the thermosetting resin is usually liquid in malleable form prior to curing, and designed to be molded into the final form. The two halves 51, 52 are shown in FIGS. 2A and 2F, 3A and 3F. As part of the injection molding process, downwardly extending section ribs 53, 54 run on the undersides of the bi-fold halves, as shown in FIGS. 2D and 2E, 3D and 3E, 4A and 4B, 6A, 7A and 9. A hinged leg assembly 55 for the bi-fold table 50 with a strut support 56 is shown in the underneath perspective view of FIGS. 2D and 3D and in the partly opened view of FIG. 4A. A fully opened view of the bi-fold center folding table 50 is shown in FIG. 2C (front view) and FIG. 2F (front perspective view), FIG. 3D (front view) and FIG. 3F (front perspective view). A bottom view of the leg assembly 55 and hinged strut 56 is shown in FIGS. 2B and 3B (left side view), with right side views being mirror images. FIGS. 8A and 8B, 8C and 8D, respectively, show front and side views of the hinge strut and leg assemblies. As will be appreciated, the hinge strut 56 couples with the leg assembly 55 in any appropriate locking arrangement, as at the holes 57 in FIG. 8B, with further holes 59 on leg assembly 55 being provided to allow coupling with additional leg assemblies (not shown) in a telescoping manner to raise or lower the height of the bi-fold table above the ground. A function box/storage compartment for the bi-fold table is shown as 60 in FIGS. 3D and 3E, 4A and 4B, and in FIG. 9. Such function box 60 is composed of a cover 75 and a frame 76, as shown in FIGS. 5A and 5D, with FIG. 5B representing a side view of a closed storage box and FIG. 5C representing an end view thereof.

Hard left and right halves of the center folding bi-fold tabletop are thus fabricated by a melamine formaldehyde thermosetting resin injection molding as single solid cores which are waterproof and printable, with underside section ribs in a single process, requiring no side aluminum trim—and thus avoiding any drilling of holes in the sides and any scratching of the table edges in installing aluminum trim, and in a simpler installation process. As will become clear from the following, such injection molding process allows for the storage underneath the tabletop surface of the function box housings 60, the leg assemblies 55, the hinge struts 56, and any extension legs—with the result being that when closed, the bi-fold center folding table of the invention takes on the appearance as shown in FIG. 4C (100).

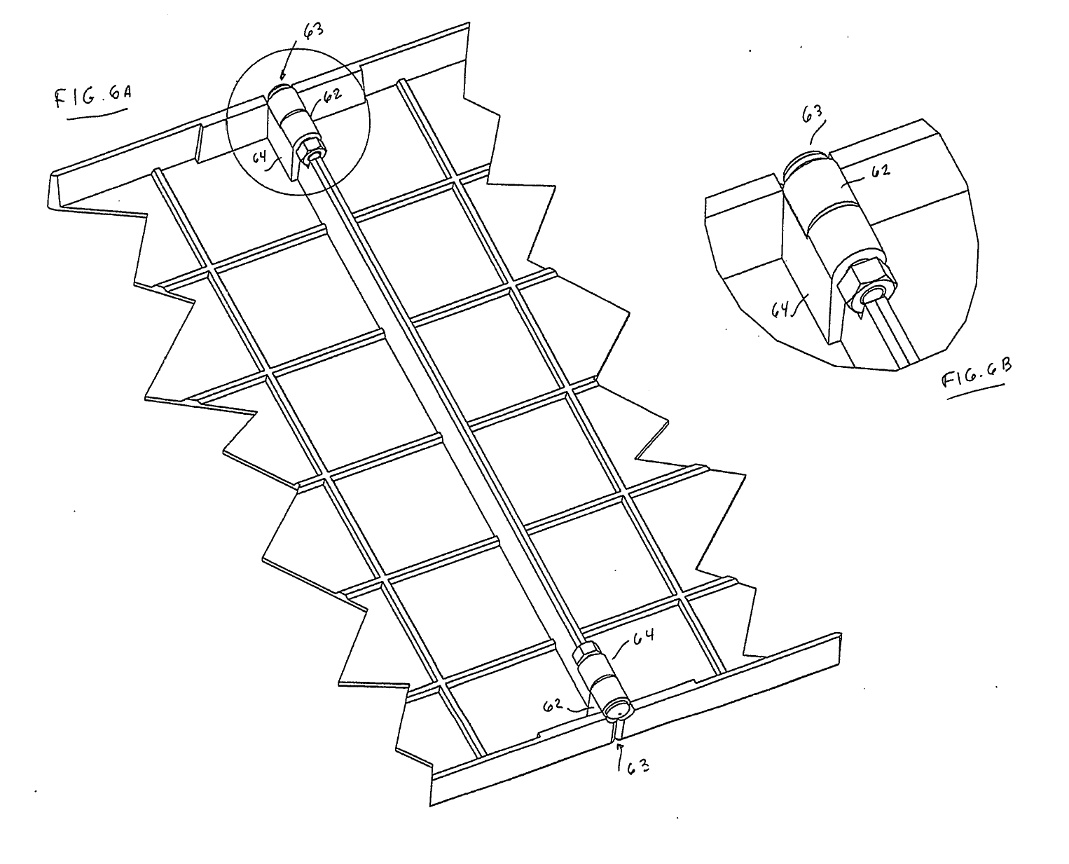

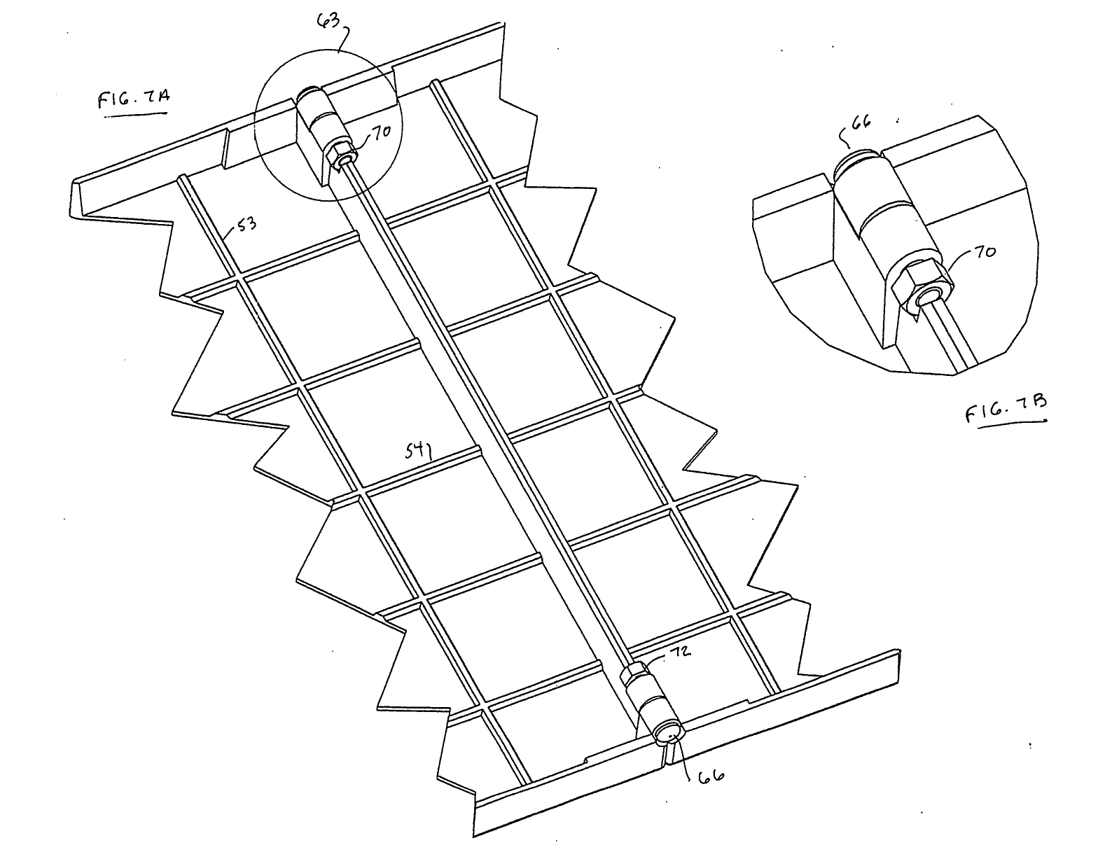

In accordance with the invention, the center folding bi-fold tabletop is thus formed of a pair of solid core halves formed through an injection molding process of a thermosetting resin, preferably of melamine formaldehyde. The tabletop halves so formed can be hinged together in several appropriate manners in controlling the opening and closing of the table. In accordance with the invention, furthermore, a preferred method of hinging is one formed through the injection molding process itself. As illustrated in FIGS. 6A and the sectional view of 6B, this is accomplished through the fabrication of a barrel hinge 63 during the injection molding process. Such hinge includes a first component 62 on one of the tabletop halves and a second component 64 on the other half, on their respective facing edges so that they meld together in the closing of the two halves. As shown in FIG. 7A and the sectional view of FIG. 7B, drive pins 66, 68 are added illustrated as a screw or bolt tightened in appropriate manner by nuts 70, 72, respectively. Although a pair of barrel hinges are illustrated in FIGS. 6A and 6B, and at 7A and 7B, one or more of these barrel hinge fabrications and securements can be employed in controlling the opening and closing of the tabletop.

And, as FIGS. 6A-6B and 7A-7B illustrate, the two tabletop halves, provided with an underneath surface lined by the section ribs 53 and 54 extend downwardly a distance to allow the function box(es) 60 to be secured to the underside of the tabletop according to the invention. Twist-type clips 80 in FIGS. 2D and 2E, 81 in FIGS. 3D and 3E, 82 in FIGS. 4A and 4B, and 83 in FIG. 9 serve to hold the function/storage box 60 in place, against a stop 84 of a locking channel 95, described below and more clearly shown in FIG. 9. The drive pin 66 is shown in the two barrel hinges illustrated in FIGS. 7A and 7B.

Pivots for rotating the leg assemblies 55 opened or closed are shown at 90 in FIGS. 2D and 2E, at 91 in FIGS. 3D and 3E, at 92 in FIGS. 4A and 4B, and at 93 in FIG. 9. Locking channels for the support struts 56 are shown as 95 in FIG. 2E, as 96 in FIG. 3E, as 97 in FIG. 4A when the leg assembly and struts are deployed, and at FIG. 4B with the leg assembly and struts in position prior to folding of the table closed (also repeated as such in FIG. 9). Reference numeral 98 in FIG. 9 identifies pairs of extension poles secured by clamps 99 for use in any heightening of the center folding table desired. As will be appreciated, the rib sections 53 and 54, the twistable locks, and the extension pole holding clasps (as well as the function boxes 60) are hidden from view with the table opened as shown in FIGS. 2C and 2F, and in FIGS. 3C and 3F, by constructing the tabletops to have an appropriate side dimension 101 in these FIG. 2A-2F and FIG. 3A-3F orientations. Or, the holding clasps could also serve to secure yet a further set of function/storage boxes.

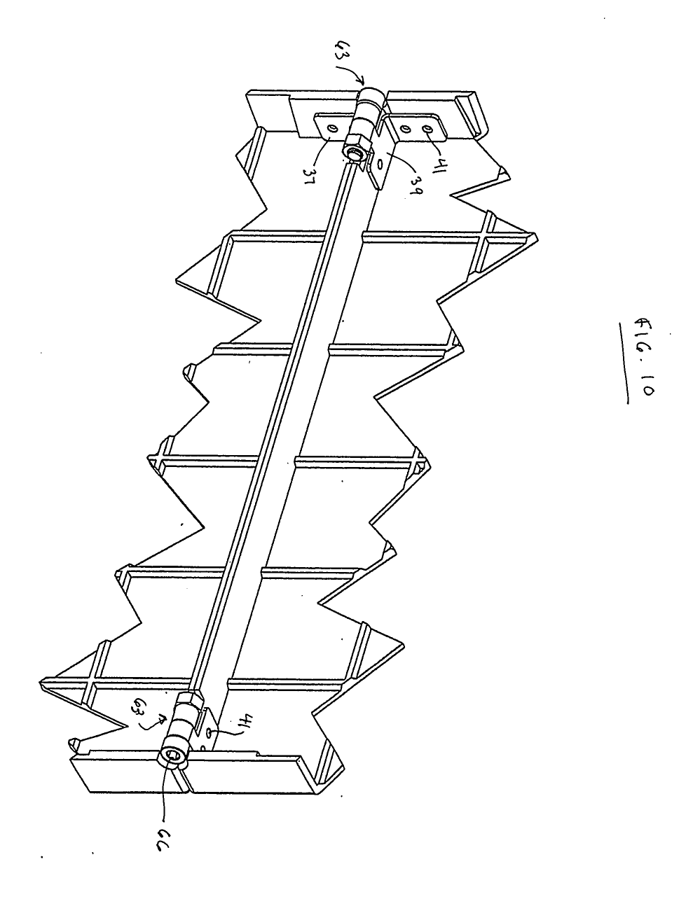

As thus described, the center folding bi-fold table of the invention becomes manufacturable as a single integral unit in an injection molded melamine process. A single-faced tabletop thereby becomes producible rather than one being “double walled” as with a blow mold process, and without the need for any aluminum wrapping as with medium density fiberboard constructions. A definite advantage that results in this manner is that “printing” can be done much easier to the tabletop as there is no protrusion of aluminum or similar metal on the top surface of the tabletop, and because the tabletop is composed of two hard core halves. With the top surface flat, silk screening also becomes available, and with the injection molding melamine process, the underside of the resulting tabletop becomes hollowed out with a side rim made of the same material in the same molding process. Likewise, the twist type clips and the locking channels can be formed as part of the molding process itself, finalized by a stamping of a metal plate or screw affixation to hold the leg assemblies, support struts, and storage boxes in position.

Whereas there have been described what are considered to be preferred embodiments of the present invention, it will be appreciated by those skilled in the art that modifications can be made without departing from the teachings herein. Thus, while the present invention is described in the context of a bi-fold, center folding table, its teachings of forming its sections through an injection molding process of a thermosetting resin—melamine formaldehyde—would apply equally as well to a fabrication where more than two sections are folded in forming the table, and/or where the sections formed are not of the same size, as with the preferably two sections being of a nature of equal “halves”. Similarly, while the description of the unit 60 is set forth as a “function box/storage compartment”, it will be apparent that that addition to the underside of the tabletop could serve as a built-in speaker music box, a bluetooth speaker, a WIFI router, or otherwise in fulfilling the applicability of the present invention to other uses. And, additionally, the described constructions even go further in providing the advantages of the invention to instances where stronger table designs might be required, in which event a further steel stamping, or like accessory can be employed, as by the plates 37, 39 of FIG. 10, securable by screws through their apertures 41 to the barrel hinge components 62, 64 on one side, and to the side edges of the tabletop at its adjacent side. This strengthening, furthermore, will be understood as a manner of strengthening the folding table whether an injection molding formed barrel hinge 63 is employed or whether the alternative hinges commonly used with the medium density fiberboard constructions are alternatively utilized instead. For at least such reasons, therefore, resort should be had to the claims defining the invention typified by the following.

I claim:

1. A center folding table comprising first and second solid core tabletop halves joined together at facing edges thereof, with the halves being formed through an injection molding process of a thermosetting resin.

2. The center folding table of claim 1 wherein said tabletop halves are formed through an injection molding process of a melamine formaldehyde thermosetting resin.

3. The center folding table of claim 1 wherein said tabletop halves are formed and hinged together through said injection molding process.

4. The center folding table of claim 1 wherein said tabletop halves are formed and hinged together through an injection molding process of a melamine formaldehyde thermosetting resin

5. The center folding table of claim 1 wherein said tabletop halves are hinged together at first and second locations along said facing edges.

6. The center folding table of claim 5 wherein said tabletop halves are hinged together at said first and second locations by a barrel hinge including a first component on one of said tabletop halves facing edges and a second intercoupling component on a facing edge of said other of said tabletop halves facing edges.

7. The center folding table of claim 6 wherein said tabletop halves are formed and hinged together through an injection molding process of a melamine formaldehyde thermosetting resin.

8. The center folding table of claim 1 wherein each of said first and second tabletop halves include a top surface, and an underneath surface lined by downwardly extending section ribs.

9. The center folding table of claim 5 wherein each of said first and second tabletop halves include a top surface, and an underneath surface lined by downwardly extending section ribs.

10. The center folding table of claim 9 including a function box/storage compartment removably coupled between adjacent section ribs on at least one of said tabletop halves.

11. The center folding table of claim 10 wherein said tabletop halves are formed and hinged together through said injection molding process.

12. The center folding table of claim 11 wherein said tabletop halves are formed and hinged together through an injection molding process of a melamine formaldehyde thermosetting resin.

13. A folding table comprising first and second solid core sections joined together at facing edges thereof, with said sections being formed through an injection molding process of a thermosetting resin.

14. The folding table of claim 13 wherein said solid core sections are formed through an injection molding process of a melamine formaldehyde thermosetting process.

15. The folding table of claim 14 wherein said solid core sections are formed and hinged together through said injection molding process.

16. The folding table of claim 14 wherein said solid core sections are formed and hinged together through an injection molding process of a melamine formaldehyde thermosetting resin.

17. The folding table of claim 15 wherein said solid core sections are hinged together at first and second locations by a barrel hinge including a first component on one of said solid core section facing edges and a second intercoupling component on a facing edge of said other of said solid core section facing edges.

18. The folding table of claim 15 wherein said solid core sections are formed and hinged together through an injection molding process of a melamine formaldehyde thermosetting resin.
